(19) United States
(12) Patent Application Publication
(10) Pub. No.: US 2016/0240020 A1
(43) Pub. Date: Aug. 18, 2016

(54) DRIVING DATA RECORDING METHOD AND DRIVING DATA RECORDER

(71) Applicant: HON HAI PRECISION INDUSTRY CO., LTD., New Taipei (TW)

(72) Inventor: PEI-CHONG TANG, New Taipei (TW)

(21) Appl. No.: 14/755,024

(22) Filed: Jun. 30, 2015

(30) Foreign Application Priority Data
Feb. 13, 2015 (CN) 201510077314.6

(51) Int. Cl. G07C 5/06; H04N 5/232; B64C 39/02

(52) U.S. Cl. CPC G07C 5/06; B64C 39/024; H04N 5/23229; B64C 2201/127; B64C 2201/14

(57) ABSTRACT

A driving data recorder for a car is provided. The driving data recorder includes: an aerial vehicle including a photographing configured to take photos of the car and surroundings around the car, a control unit configured to generate propulsion commands, and a propulsion unit configured to move the aerial vehicle according to the propulsion commands; and a trigger unit configured to generate control signals when a car has an accident, wherein the control signals are configured to enable the control unit.

### FIELD

The subject matter herein generally relates to a method and a device for data recording, especially relates to a method and a device for recording driving data.

### BACKGROUND

Many vehicles use a driving data recorder, commonly known as a “black box,” to record driving data for accident reconstruction. Currently available driving data recorders are fixed in the vehicle and do not have a capability of photographing the environment around the vehicle from multiple angels, therefore, the recorded driving data is not enough for accident reconstruction. Accordingly, there is a need for a method and device for driving data recording which can provide more effective driving data for accident reconstruction.

### BRIEF DESCRIPTION OF THE DRAWINGS

Implementations of the present technology will now be described, by way of example only, with reference to the attached figures.

FIG. 1 is a diagrammatic view of an exemplary embodiment of a car and a driving data recorder.

FIG. 2 is a diagrammatic view of an exemplary embodiment of an aerial vehicle.

FIG. 3 is block diagram of an exemplary embodiment of a driving data recorder.

FIG. 4 is block diagram of an exemplary embodiment of a control unit of a driving data recorder.

FIG. 5 is a diagrammatic view of an exemplary embodiment of a trajectory of an aerial vehicle.

FIG. 6 is a flowchart of an exemplary embodiment of a driving data recording method.

FIG. 7 is a flowchart of another exemplary embodiment of a driving data recording method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

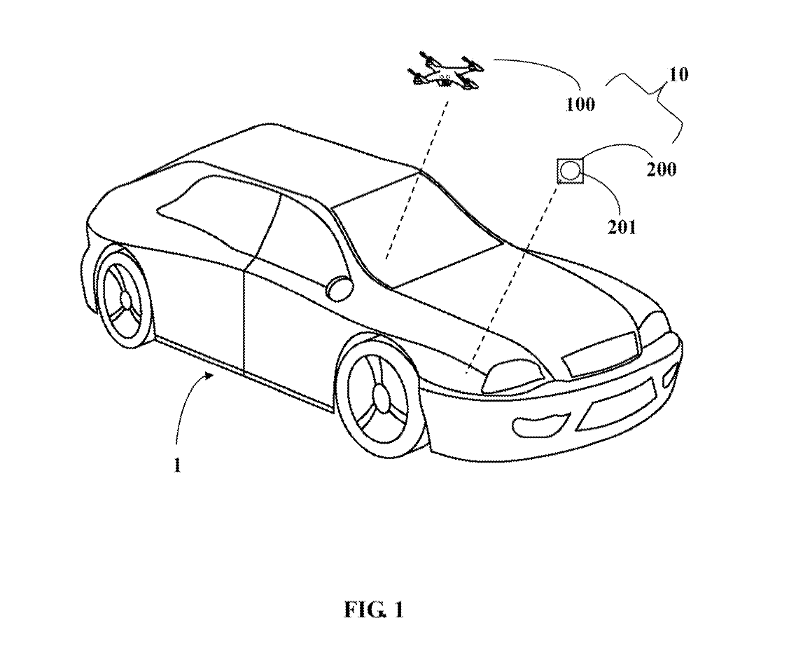

FIG. 1 illustrates a diagrammatic view of an exemplary embodiment of a car 1 and a driving data recorder 10. The driving data recorder can include an aerial vehicle 100 and a trigger unit 200. The aerial vehicle 100 can be positioned inside a car or outside a car, and can be configured to record driving data involved the car. In the exemplary embodiment, the aerial vehicle 100 can be positioned inside a car (not shown). The driving data recorder 10 can be positioned in any suitable ways, for example, in a similar way as a conventional driving data in which the aerial vehicle 100 can be locked through a locking device which can be stick onto a front windscreen of the car 1. In the exemplary embodiment, the aerial vehicle 100 can be controlled to fly out off the car from a window of the car, for example, skylight, a left window or a right window. In the exemplary embodiment, the locking device can be switched between a locked station where the aerial vehicle 100 is locked at the locking device and an unlocked station where the aerial vehicle 100 can take off from the locking device.

In at least one embodiment, the aerial vehicle 100 can be positioned at any suitable portion of the head of outside of the car. For example, the aerial vehicle 100 can be positioned at a left side of the front windscreen or a right side of the front windscreen without obstructing field of view of a driver of the car.

The trigger unit 200 can include a trigger switch 201 configured to generate control signals when the car is suffering a car crash. The control signals can cause the aerial vehicle 100 to fly away from the vehicle so that can photograph the car in a wide range of view to capture more detail data for crash reconstruction. The trigger unit 200 can be positioned any suitable portion of the car and the trigger switch can be any suitable type of trigger switch which can be triggered when the car is suffering a car crash. For example, the trigger switch 201 can be a pressure switch. In at least one embodiment, the trigger switch 201 can be a shock sensor which can be triggered by specific shock due to a car crash. The trigger unit 200 can be positioned at a head of the car where the car most likely to be hit. In at least one embodiment, the number of the trigger switch 201 can be more than one and can be positioned at different portion of the car respectively. The trigger unit 200 can communicated with the aerial vehicle 100 through any suitable ways, for example, wired communications or wireless communications including Blue Tooth, Wi-Fi, Infrared Data Association (IrDA) or Near Field Communication (NFC). In such a way, the control signals are transmitted from the trigger unit 200 to the aerial vehicle 100. In at least one embodiment, the trigger unit 200 can be configured to generate control signals to cause the locking device to be switched to the unlocked station so that the aerial vehicle 100 can take off. In at least one embodiment, where the aerial vehicle 100 is poisoned within the car, the trigger unit 200 can be configured to generate a control signal to open a corresponding window, for example, skylight, left or right window.

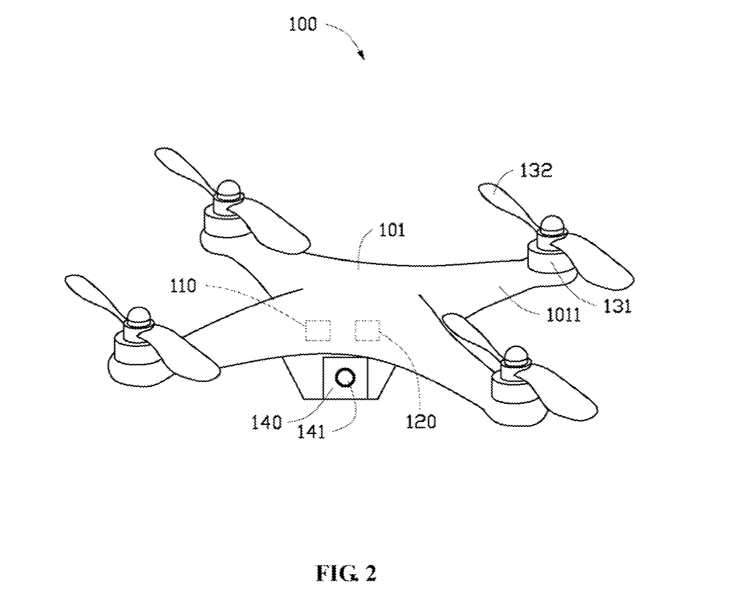

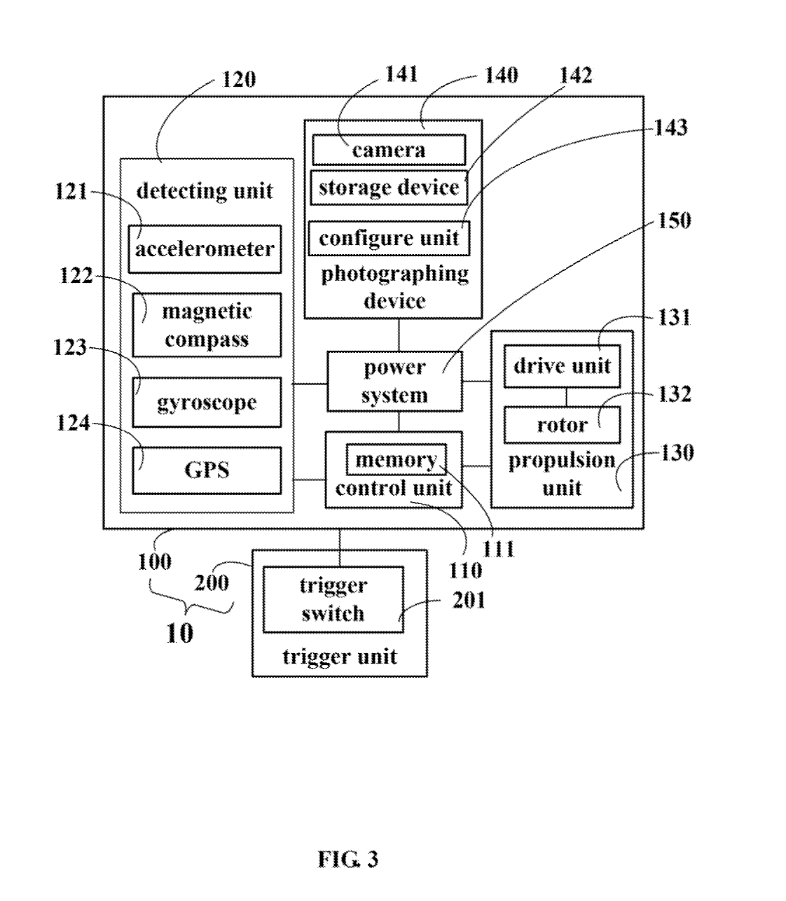

In a further exemplary embodiment, the aerial vehicle 100 can be a helicopter driven by at least one rotor. Referring to FIGS. 2 and 3, the aerial vehicle 100 can include a central body 101 and a control unit 110 positioned at the central body 101, a detecting unit 120, a propulsion unit 130, a photographing device 140, and a power system 150 configured to supply power to the aerial vehicle 100.

The control unit 110 can communicate with the detecting unit 120 and the propulsion unit 130. The control unit 110 can be configured to receive control signals from the trigger unit 200 to generate control commands to the detecting unit 120 to enable the detecting unit 120 to detect current flight data of the aerial vehicle 100. The control unit 110 further can be configured to receive the current flight data of the aerial vehicle 100 to generate propulsion commands to the propulsion unit 130 to control flight of the aerial vehicle. The control unit 110 can include a memory 111 configured to store computerized instructions which can be performed by the integrated chip or the processor to control operations of the aerial vehicle 100.

The detecting unit 120 can be configured to detect current flight data of the aerial vehicle 100 during flight of the aerial vehicle 100. The detecting unit 120 can include, but not limited to, an accelerometer 121, a magnetic compass 122, a gyroscope 123, and a Global Position System (GPS) 124. The accelerometer 121 can be configured to detect current motion data of the aerial vehicle 100, for example, current acceleration, and current velocity. The magnetic compass 122 can be configured to detect current attitude data, for example, current pitch angles, and current rotation angles. The gyroscope 123 can be configured to detect current angular velocity of the aerial vehicle 100. The GPS 124 can be configured to detect current position data, for example, covered distance, coordinates of current position, and current altitude.

The propulsion unit 130 can include a plurality of drive unit 131 and at least one rotor 132. In the exemplary embodiment, the drive unit 130 can include four drive units 131 and four rotors respectively corresponding to the four drive units 131. Each drive unit 131 can be configured to drive a rotor 132 to rotate so as to move the aerial vehicle 100. Referring to FIG. 1, the central body 101 extends substantially symmetrically arranged four arms 1011. Four rotors 132 are respectively positioned at an end of the four arms 1011. Each drive unit 131 receives propulsion commands from the control unit 110 and drives a corresponding rotor 132 to rotate in response to the propulsion commands. The rotation of the rotor can generate a pull force to move the aerial vehicle 100. The aerial vehicle 100 can be controlled to vertical takeoff and/or land, level fly, level rotate, tilted fly, stay in air through controlling rotation of the rotor 132. In the exemplary embodiment, the drive unit 131 can be a motor. In at least one embodiment, the number of the rotor 132 and the drive unit 131 can be modified as needed, for example, six or eight.

The photographing device 140 can include at least one camera 141, at least one storage device 142, and a configure unit 143. The camera 141 can be configured to photograph the car and surroundings around the car. In the exemplary embodiment, the camera 141 can be a

Wide Field Camera (WFC). The storage device 142 can be configured to store images photographed by the camera 141. The configure unit 143 can be configured to configure operation parameters of the camera, for example, frequency of photographing, number of shooting spot, and view angles of the camera. The number of shooting spot can be configured to any value as needed, for example, 8, 16, 24 and 32. The view angles can be modified to suite for different conditions. For example, when the car in a normal driving condition, the view angle of the camera 141 can be constant, for example, towards the front of the car, while, when the car has an accident, the aerial vehicle 100 takes off away from the car, the view angle of the camera 141 can be modified to take more efficient images.

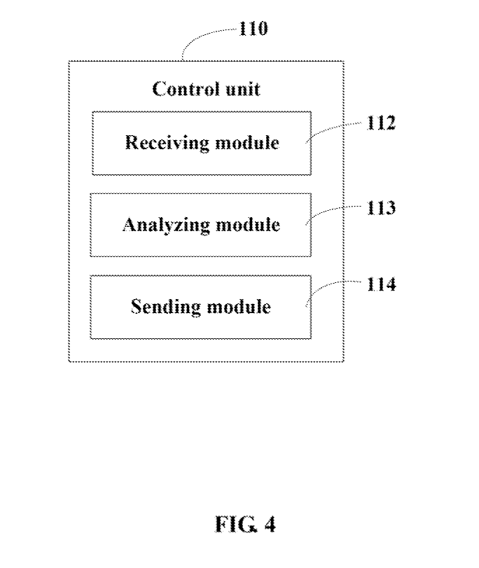

Referring to FIG. 4, a block diagram of an exemplary embodiment of a control unit of a driving data recorder is illustrated. The control unit 110 can include an integrated chip or a processor, including at least one of a single chip, a central processing unit (CPU), a microprocessor, or other data processor chip that performs functions of the aerial vehicle 100.

The computerized instructions can be in the form of one or more programs. In the embodiment, the control unit 110 can include one or more modules, for example, a receiving module 112, an analyzing module 113, and a sending module 114. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

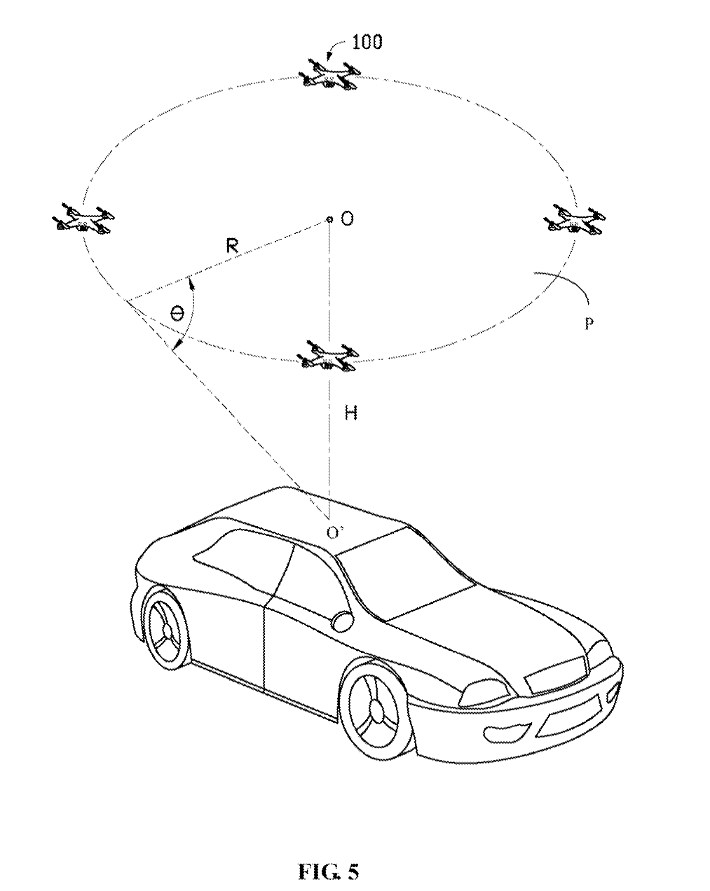

The receiving module 112 can be configured to receive control signals from the trigger unit 200 and control the aerial vehicle 100 to fly in a predefined way in response to the control signals. In the exemplary embodiment, the aerial vehicle 100 can fly to a parallel plane and fly along a circle in the parallel plane. Referring to FIG. 5, an exemplary trajectory of the aerial vehicle 100 is illustrated. Firstly, the aerial vehicle 100 can be controlled to fly away from the car to a parallel plane P to which the distance from the car is H. Then, the aerial vehicle 100 can be controlled to fly along a circle with a radius R and a center O corresponding to a center O′ of the car. The photographing device 140 of the aerial vehicle 100 can take photos of the car and surroundings around the car during flight. Finally, the aerial vehicle can be controlled to land at the car after finished photographing. The flight of the aerial vehicle 100 can be controlled to be one or more circles. The flight time of the aerial vehicle 100 can depend on the power supply of the power system 150. In the exemplary embodiment, the radius R can be 10 m, 15 m, 20 m, or 25 m. In at least one embodiment, the radius R can be any suitable value. The distance H and the radius R can be configured to any suitable values which are desirable to provide a wide range of field of view for the photographing device 140. In at least one embodiment, the aerial vehicle 100 can be controlled fly along any suitable trajectory, for example, triangle or other polygon. In at least one embodiment, the aerial vehicle 100 can hover at a predefined altitude above the car for a predefined time interval.

The camera 141 can has a view angle θ which is defined as an angle between the line of sight of the camera 141 and the parallel plane P. The view angle θ can be defined in advance. The view angle θ can be less than 90 degree. In the exemplary embodiment, the view angle θ can be configured to satisfy: tan θ=H/R.

In the exemplary embodiment, the receiving module 112 can further configured to receive control signals from the trigger unit 200 and control the detecting unit 120 to detect flight data during flight of the aerial vehicle 100. The flight data can include, but not limited to, motion data (for example, velocity and acceleration), attitude data (for example, pitch angel and rotation angle), and position data (for example, coordinates of current position, altitude, and translation distance).

The analyzing module 113 can be configured to store the flight data from the detecting unit 120 and analyze the flight data. The analyzing module 113 can be configured to comparing the received flight data with predefined flight data to generate propulsion commands.

The sending module 114 can be configured to send the propulsion commands to the propulsion unit 113 so as to control the flight of the aerial vehicle 100 based on the propulsion commands.

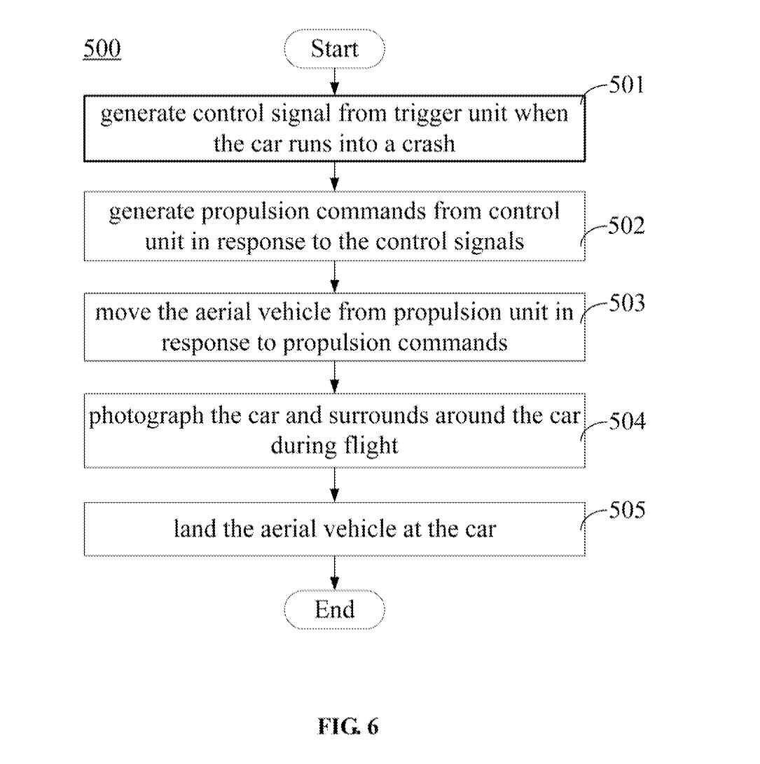

Referring to FIG. 6, a flowchart is presented in accordance with an example embodiment of a driving data recording method which is being thus illustrated. The example method 500 is provided by way of example, as there are a variety of ways to carry out the method. The method 500 described below can be carried out using the configurations illustrated in FIGS. 1, 2, 3, 4 and 5, for example, and various elements of the figure is referenced in explaining example method 500. Each block shown in FIG. 6 represents one or more processes, methods or subroutines, carried out in the exemplary method 500. Furthermore, the illustrated order of blocks is by example only and the order of the blocks can change according to the present disclosure. Additional blocks may be added or fewer blocks may be utilized, without departing from this disclosure. The exemplary method 500 can be executed by a driving data recorder, and can begin at block 501. The driving data recorder can include a trigger unit and an aerial vehicle 100. The aerial vehicle can include a camera configured to take images of the car and surroundings around the car, a control unit configured to generate propulsion commands in response the control signals from the trigger unit, and a propulsion unit configured to move the aerial vehicle according to the propulsion commands.

At block 501, when the car has an accident, the trigger unit generates control signals to be sent to the control unit.

At block 502, the control unit generates propulsion commands in response to the control signals. In detail, the control unit generates propulsion commands based on a predefined flight data including at least one of velocity, acceleration, attitude, altitude, flight time, or trajectory.

At block 503, the propulsion unit moves the aerial vehicle in response to the propulsion commands.

At block 504, the camera photographs the car and the surroundings around the car during flight of the aerial vehicle. In at least one exemplary embodiment, images photographed by the photographing device can be stored into a storage device for accident reconstruction.

At block 505, the control unit controls the aerial vehicle to land at the car.

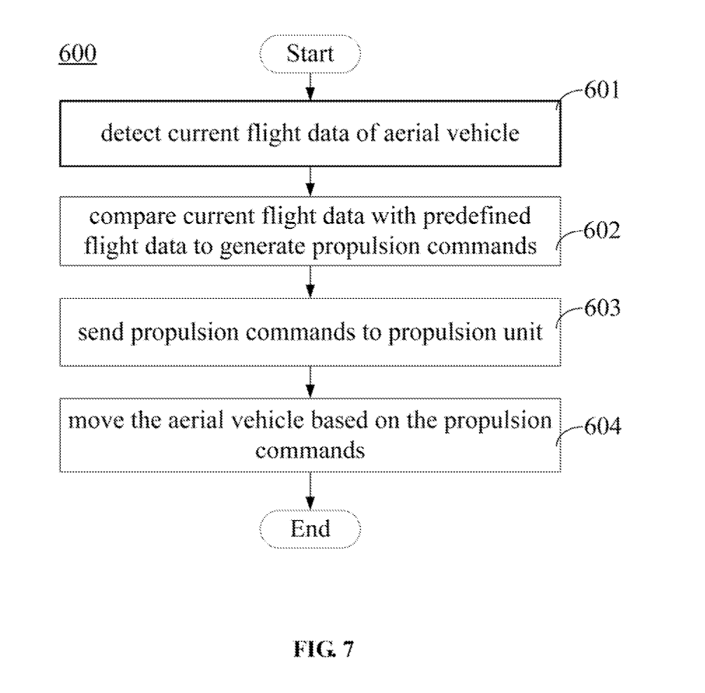

Referring to FIG. 7, a flowchart is presented in accordance with another example embodiment of a driving data recording method which is being thus illustrated. The example method 600 is provided by way of example, as there are a variety of ways to carry out the method. The method 600 described below can be carried out using the configurations illustrated in FIGS. 1, 2, 3, 4 and 5, for example, and various elements of the figure is referenced in explaining example method 600. Each block shown in FIG. 7 represents one or more processes, methods or subroutines, carried out in the exemplary method 600. Furthermore, the illustrated order of blocks is by example only and the order of the blocks can change according to the present disclosure. Additional blocks may be added or fewer blocks may be utilized, without departing from this disclosure. The exemplary method 600 can be executed by a driving data recorder, and can begin at block 601. The driving data recorder can include a trigger unit and an aerial vehicle 100. The aerial vehicle can include a detecting unit configured to detect current flight data of the aerial vehicle, a control unit configured to generate propulsion commands in response to the current flight data, and a propulsion unit configured to move the aerial vehicle based on the propulsion commands.

At block 601, the detecting unit detects current flight data of the aerial vehicle. The flight data can include, but not limited to, motion data (for example, velocity and acceleration), attitude data (for example, pitch angel and rotation angle), and position data (for example, coordinates of current position, altitude, and translation distance).

At block 602, the control unit analyzes the current flight data and generates propulsion commands to be sent to the propulsion unit. In detail, the control unit compares current flight data with predefined flight data to generate propulsion commands which can modify current flight condition to a desirable flight condition.

At block 603, the control unit sends the propulsion commands to the propulsion unit.

At block 604, the propulsion unit moves the aerial vehicle in a desirable way according to the propulsion commands. An exemplary desirable way is illustrated in FIG. 4. In the exemplary embodiment, the aerial vehicle takes off away from the car and vertically flies to an attitude H, and then hovers at least one circle in the parallel plane P.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A driving data recorder, comprising:
an aerial vehicle including a photographing configured to take photos of the car and surroundings around the car, a control unit configured to generate propulsion commands, and a propulsion unit configured to move the aerial vehicle according to the propulsion commands; and
a trigger unit configured to generate control signals when a car has an accident, wherein the control signals are configured to enable the control unit.

2. The driving data recorder according to claim 1, wherein the propulsion unit moves the aerial vehicle in a predefined way including taking off from the car, flying to a predefined altitude H and hovering at least one circle in a parallel plane.

3. The driving data recorder according to claim 2, wherein the photographing device operates at an angle θ between view of the photographing device and a horizontal line, wherein θ satisfies: tan θ=H/R, H representing altitude of the aerial vehicle, R representing radius of the circle.

4. The driving data recorder according to claim 3, wherein the photographing device operates at a constant angle where the photographing device towards the front of the car when the car is driven normally.

5. The driving data recorder according to claim 1, further comprising a detecting unit configured to detect current flight data.

6. The driving data recorder according to claim 5, wherein the flight data comprises current position data, angular velocity, attitude data and motion data.

7. The driving data recorder according to claim 5, wherein the detect unit includes a global position system configured to detect current position data, an accelerometer configured to detect current velocity and current acceleration, a magnetic compass configured to detect current attitude data, and a gyroscope configured to detect current angular velocity.

8. The driving data recorder according to claim 5, wherein the control unit further configured to analyze current flight data to generate modified propulsion commands.

9. The driving data recorder according to claim 1, wherein the propulsion unit comprises at least one drive unit and at least one rotor, wherein the drive unit is configured to drive the rotor to rotate to operate the aerial vehicle.

10. The driving data recorder according to claim 1, wherein the aerial vehicle includes a central body, and at least one arm extending from the central body, the at least one rotor being poisoned at an end of a corresponding arm.

11. The driving data recorder according to claim 1, wherein the photographing device includes at least one camera, a configure unit configured to configure operation parameters of the at least one camera, and a storage device configured to store images taken by the at least one camera.

12. The driving data recorder according to claim 1, wherein the operation parameters include frequency of photographing, number of shooting spot, and view angles of the camera.

13. A driving data recording method for a driving data recorder, wherein the driving data recorder comprises a trigger unit, and an aerial vehicle including a photographing device configured to photograph a car and surroundings around the car, a control unit configured to generate propulsion commands and a propulsion unit configured to move the aerial vehicle according to the propulsion commands, the method comprising:
generating, at the trigger unit, control signals when the car has an accident, wherein the control signals are configured to enable the control unit;
generating, at the control unit, propulsion commands;
moving, at the propulsion unit, the aerial vehicle in a predefined way according to the propulsion commands; and
photographing, at the photographing device, the car and the surroundings around the car.

14. The method according to claim 13, further comprising:
detecting, at the aerial vehicle, current flight data of the aerial vehicle;
analyzing, at the control unit, the current flight data;
generating, at the control unit, propulsion commands based on analyzed result; and
moving, at the propulsion unit, the aerial vehicle according to the propulsion commands.

15. The method according to claim 14, wherein the flight data comprises current position data, angular velocity, attitude data and motion data.

16. The method according to claim 13, wherein the predefined way includes taking off from the car, flying to a predefined altitude H and hovering at least one circle in a parallel plane.

17. The method according to claim 16, wherein the photographing device operates at an angle θ between view of the photographing device and a horizontal line, wherein θ satisfies: tan θ=H/R, H representing altitude of the aerial vehicle, R representing radius of the circle.

18. The method according to claim 17, further comprising: photographing, at the photographing device, the car and the surroundings around the car with a constant angle which is towards the front of the car when the car is driven normally.

19. The method according to claim 13, further comprising: storing, at the photographing device, images photographed by the photographing device.
